(19) United States
(12) Patent Application Publication
(10) Pub. No.: US 2023/0123273 A1
(43) Pub. Date: Apr. 20, 2023

(54) MANAGEMENT DEVICE, MANAGEMENT SYSTEM, MONITORING SYSTEM, ESTIMATING METHOD, ANDRECORDING MEDIUM

(71) Applicants: NEC Corporation, Minato-ku, Tokyo (JP); NEC Solution Innovators, Ltd., Koto-ku, Tokyo (JP)

(72) Inventors: Satoshi Hirata, Tokyo (JP); Hajime Yamashita, Tokyo (JP); Genki Yamamoto, Tokyo (JP); Masafumi Shibata, Tokyo (JP); Dai Hashimoto, Tokyo (JP); Takahiro Kimoto, Tokyo (JP); Youhei Takahashi, Tokyo (JP)

(73) Assignees: NEC Corporation, Minato-ku, Tokyo (JP); NEC Solution Innovators, Ltd., Koto-ku, Tokyo (JP)

(21) Appl. No.: 17/909,547

(22) PCT Filed: Mar. 31, 2020
(86) PCT No.: PCT/JP2020/014900

§ 371 Date: Sep. 6, 2022

(51) Int. Cl. G06V 20/40; H04N 7/18; H04N 5/77; G06V 20/52; G06V 40/20

(52) U.S. Cl. CPC G06V 20/44; H04N 7/181; H04N 5/77; G06V 20/53; G06V 40/20; G06V 2201/10

(57) ABSTRACT

A management device that includes an instruction unit that acquires metadata of video data of an area to be monitored generated by a monitoring terminal that detects an event from the video data, outputs, in response to an acquisition of metadata including information about the event, an analysis instruction for the video data of the area to be monitored imaged in a time zone including a time of detection of the event to a video analysis device that detects the event from the video data, and acquires an analysis result including information about the event detected from the video data by an analysis by the video analysis device, and an estimation unit that estimates a case event that has occurred in the area to be monitored based on the event detected by the monitoring terminal and the event detected by the video analysis device.

### TECHNICAL FIELD

The present invention relates to a management device or the like that detects an event from video data.

### BACKGROUND ART

In monitoring using a general monitoring camera, the surveillance staff confirms videos imaged by a plurality of monitoring cameras installed on a street and determines case events such as a crime and an accident that have occurred on the street. When the monitoring camera or the analysis server can detect individual events accompanying the case event before the surveillance staff actually checks the video, it is easy to determine the occurred case event.

PTL 1 discloses a monitoring device that detects a moving object from a video obtained by capturing an image of a monitored base. The device of PTL 1 determines, for each divided group, whether the group includes a difference frame having a data size equal to or larger than a predetermined threshold value with respect to the video data divided in units of groups including a plurality of frames in chronological order. The device of PTL 1 performs decoding process on a plurality of frames of a group determined to include a difference frame having a data size equal to or larger than a predetermined threshold value. The device of PTL 1 detects a moving object by performing an image analysis on each decoded frame.

PTL 2 discloses a monitoring system in which a server and a plurality of cameras installed in a monitoring area is communicably connected to each other. The server determines, for each camera, processing to be executed by the camera regarding detection of an object appearing in a captured image obtained by each camera based on the information about the processing capability of the camera. The server transmits an execution instruction of the determined processing for each camera. Each camera executes processing related to the execution instruction based on the execution instruction of the processing transmitted from the server.

### CITATION LIST

### Patent Literature

### [PTL 1] JP 2015-170874 A

### [PTL 2] JP 2018-205900 A

### SUMMARY OF INVENTION

### Technical Problem

According to the method of PTL 1, a moving object can be detected by performing an image analysis on each of a plurality of frames of a group determined to include a difference frame having a data size equal to or larger than a predetermined threshold value. However, in the method of PTL 1, a moving object can be detected, but what kind of event has occurred cannot be detected.

According to the method of PTL 2, processing such as learning of parameters used for detecting an object in captured images captured by a plurality of cameras is distributed among the plurality of cameras, an increase in traffic on a network is suppressed, and then a processing load of a server can be reduced. However, in the method of PTL 2, it is possible to detect individual events, but it is not possible to estimate the case event that is the basis of these events.

An object of the present invention is to provide a management device capable of estimating a case event based on video data.

### Solution to Problem

A management device according to an aspect of the present invention includes an instruction unit that acquires metadata of video data of an area to be monitored generated by a monitoring terminal that detects an event from the video data, outputs, in response to an acquisition of metadata including information about the event, an analysis instruction for the video data of the area to be monitored imaged in a time zone including a time of detection of the event to a video analysis device that detects the event from the video data, and acquires an analysis result including information about the event detected from the video data by an analysis by the video analysis device, and an estimation unit that estimates a case event that has occurred in the area to be monitored based on the event detected by the monitoring terminal and the event detected by the video analysis device.

In a management method according to an aspect of the present invention, the method, executed by a computer, includes outputting, in a case where metadata of video data of an area to be monitored generated by a monitoring terminal that detects an event from the video data includes information about the event, an analysis instruction for the video data of the area to be monitored imaged in a time zone including a time of detection of the event to a video analysis device that detects the event from the video data, acquiring an analysis result including information about the event detected from the video data by an analysis by the video analysis device, and estimating a case event that has occurred in the area to be monitored based on the event detected by the monitoring terminal and the event detected by the video analysis device.

In a program according to an aspect of the present invention, the program causes a computer to execute processing of: outputting, in a case where metadata of video data generated by a monitoring terminal that detects an event from the video data of an area to be monitored includes information about the event, an analysis instruction for the video data of the area to be monitored imaged in a time zone including a time of detection of the event to a video analysis device that detects the event from the video data; acquiring an analysis result including information about the event detected from the video data by an analysis by the video analysis device; and estimating a case event that has occurred in the area to be monitored based on the event detected by the monitoring terminal and the event detected by the video analysis device.

### Advantageous Effects of Invention

According to the present invention, it is possible to provide a management device or the like capable of estimating a case event based on video data.

### BRIEF DESCRIPTION OF DRAWINGS

FIG. 1 is a block diagram illustrating an example of a configuration of a monitoring system according to a first example embodiment.

FIG. 2 is a block diagram illustrating an example of a configuration of a management device included in the monitoring system according to the first example embodiment.

FIG. 3 is a block diagram illustrating an example of a configuration of a monitoring terminal included in the monitoring system according to the first example embodiment and a monitoring data recording device.

FIG. 4 is a block diagram illustrating an example of a configuration of a monitoring data recording device included in the monitoring system according to the first example embodiment and other devices.

FIG. 5 is a block diagram illustrating an example of a configuration of a management device included in the monitoring system according to the first example embodiment and other devices.

FIG. 6 is a table summarizing an example of case events to be estimated by a management device included in the monitoring system according to the first example embodiment.

FIG. 7 is a table summarizing an example of case events estimated by combining detection items by a monitoring terminal and a video monitoring device included in the monitoring system according to the first example embodiment.

FIG. 8 is a block diagram illustrating an example of a configuration of the video analysis device included in the monitoring system according to the first example embodiment and other devices.

FIG. 9 is a block diagram illustrating an example of a configuration of the management terminal included in the monitoring system according to the first example embodiment and other devices.

FIG. 10 is a flowchart for explaining an example of an operation of the monitoring terminal included in the monitoring system according to the first example embodiment.

FIG. 11 is a flowchart for explaining an example of an operation of a monitoring data recording device included in the monitoring system according to the first example embodiment.

FIG. 12 is a flowchart for explaining an example of an operation of the management device included in the monitoring system according to the first example embodiment.

FIG. 13 is a flowchart for explaining an example of an operation of the video analysis device included in the monitoring system according to the first example embodiment.

FIG. 14 is a flowchart for explaining an example of an operation of the management terminal included in the monitoring system according to the first example embodiment.

FIG. 15 is a block diagram illustrating an example of a configuration of a management device according to a second example embodiment.

FIG. 16 is a block diagram illustrating an example of a hardware configuration included in a device or a terminal according to each example embodiment.

### EXAMPLE EMBODIMENT

Hereinafter, embodiments of the present invention will be described with reference to the drawings. However, the example embodiments described below have technically preferable limitations for carrying out the present invention, but the scope of the invention is not limited to the following. In all the drawings used in the following description of the example embodiment, the same reference numerals are given to the same parts unless there is a particular reason. In the following example embodiments, repeated description of similar configurations and operations may be omitted. The directions of the arrows in the drawings illustrate an example, and do not limit the directions of signals between blocks.

### First Example Embodiment

First, a monitoring system according to a first example embodiment will be described with reference to the drawings. The monitoring system of the present example embodiment estimates a case event that has occurred in an area to be monitored based on an event detected by a monitoring terminal and an event detected by an analysis server.

(Configuration)

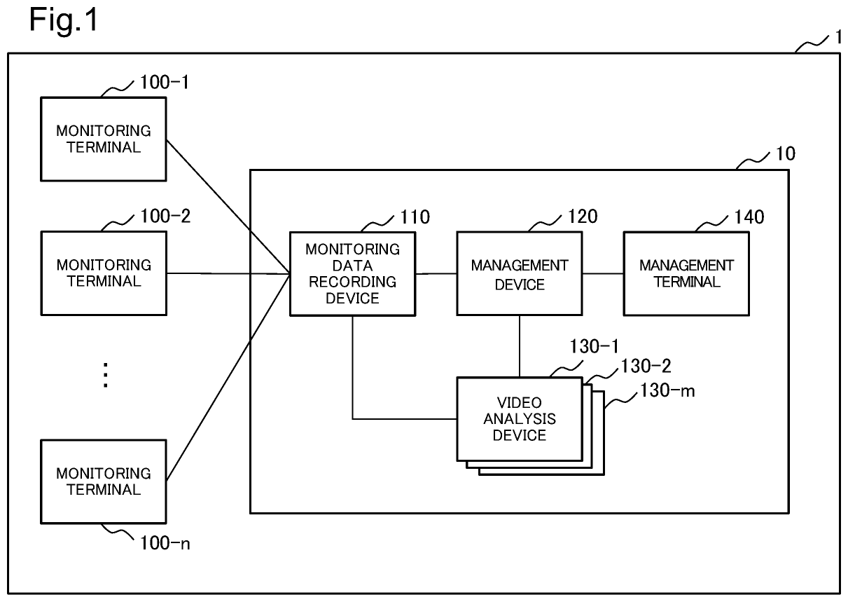

FIG. 1 is a block diagram illustrating an example of a configuration of a monitoring system 1 of the present example embodiment. As illustrated in FIG. 1, the monitoring system 1 includes monitoring terminals 100-1 to n, a monitoring data recording device 110, a management device 120, video analysis devices 130-1 to m, and a management terminal 140 (m and n are natural numbers). The monitoring data recording device 110, the management device 120, the video analysis device 130, and the management terminal 140 constitute a management system 10. In the present example embodiment, the management terminal 140 is configured separately, but the management terminal 140 may be included in the management device 120 or the video analysis device 130.

Each of the monitoring terminals 100-1 to n is disposed at a position where an image of an area to be monitored can be imaged. For example, the monitoring terminals 100-1 to n are disposed on a street or in a room with many people. Hereinafter, in a case where the individual monitoring terminals 100-1 to n are not distinguished from each other, they are referred to as a monitoring terminal 100 with reference signs omitted.

The monitoring terminal 100 captures an image of an area to be monitored to generate video data. The monitoring terminal 100 generates monitoring data in which the generated video data is associated with metadata of the video data. For example, the monitoring terminal 100 associates metadata including a place where the monitoring terminal 100 is disposed, an individual identification number of the monitoring terminal 100, an imaging time of the video data, and the like with the video data.

The monitoring terminal 100 analyzes the imaged video data and detects an event occurring in the area to be monitored. For example, the monitoring terminal 100 functions as an edge computer that analyzes each frame image constituting the video data and detects an event occurring in the area to be monitored. For example, the monitoring terminal 100 estimates what the moving object is from the size and shape of the moving object detected from the video data. For example, in a case where the moving object detected from the video data is estimated to be a person, the monitoring terminal 100 detects an event such as tumbling of the person based on a change in the aspect ratio of the person detected from the video data. For example, the monitoring terminal 100 detects an event such as a person-in-nap, carrying away something, leaving something, a crowd, tumbling, speed change, or wandering. When an event is detected from the video data, the monitoring terminal 100 adds the type of the detected event to the metadata. When the type of the event is added to the metadata, the imaging time of the video data corresponds to the time when the event is detected (hereinafter, it is also referred to as a time of detection). The time of detection of the event can be regarded as the same time as the occurrence time of the event. The monitoring terminal 100 outputs the generated monitoring data to the monitoring data recording device 110.

The monitoring data recording device 110 acquires monitoring data from the monitoring terminal 100. The monitoring data recording device 110 records the monitoring data for each monitoring terminal 100 that is a transmission source of the monitoring data.

The monitoring data recording device 110 outputs the metadata included in the monitoring data to the management device 120 at a preset timing. For example, when acquiring the monitoring data from the monitoring terminal 100, the monitoring data recording device 110 immediately outputs the metadata included in the monitoring data to the management device 120. For example, the monitoring data recording device 110 may be configured to output metadata included in the accumulated monitoring data to the management device 120. For example, the monitoring data recording device 110 outputs the metadata included in the monitoring data to the management device 120 at predetermined time intervals. For example, when receiving a request for metadata in a certain time zone from the management device 120, the monitoring data recording device 110 outputs the metadata in the time zone to the management device 120 as a transmission source in response to the request.

The monitoring data recording device 110 outputs the video data included in the monitoring data to the video analysis device 130 at a preset timing. For example, the monitoring data recording device 110 outputs the video data included in the monitoring data to the video analysis device 130 at predetermined time intervals. For example, when receiving a request for video data in a certain time zone from the video analysis device 130, the monitoring data recording device 110 outputs the video data in the time zone to the video analysis device 130 as a transmission source in response to the request.

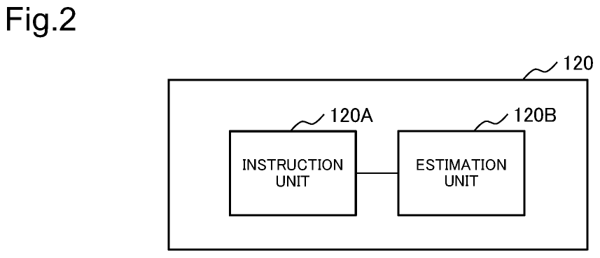

FIG. 2 is a block diagram illustrating an example of a configuration of the management device 120. The management device 120 includes an instruction unit 120A and an estimation unit 120B. Instruction unit 120A acquires the metadata included in the monitoring data from monitoring data recording device 110. The instruction unit 120A refers to the metadata included in the monitoring data and determines whether an event is detected in the video data included in the monitoring data. When the metadata includes the type of the event, the instruction unit 120A outputs an analysis instruction for the video data of the area to be monitored in which the event is detected in the time zone including a time of detection of the event to any of the plurality of video analysis devices 130-1 to m. At this time, the instruction unit 120A determines the output destination of the analysis instruction according to the operating status of the video analysis device 130.

The video data of the area to be monitored in which the event is detected may be video data imaged by the monitoring terminal 100 that is the detection source of the event or may be video data imaged by the monitoring terminal 100 that is not the detection source of the event. For example, when a plurality of monitoring terminals 100 captures an image of the same area to be monitored, an analysis instruction for each piece of video data of the area to be monitored imaged by the monitoring terminals 100 may be output to the video analysis device 130. For example, an analysis instruction for each piece of video data of the area to be monitored imaged by the plurality of monitoring terminals 100 may be allocated to the plurality of video analysis devices 130.

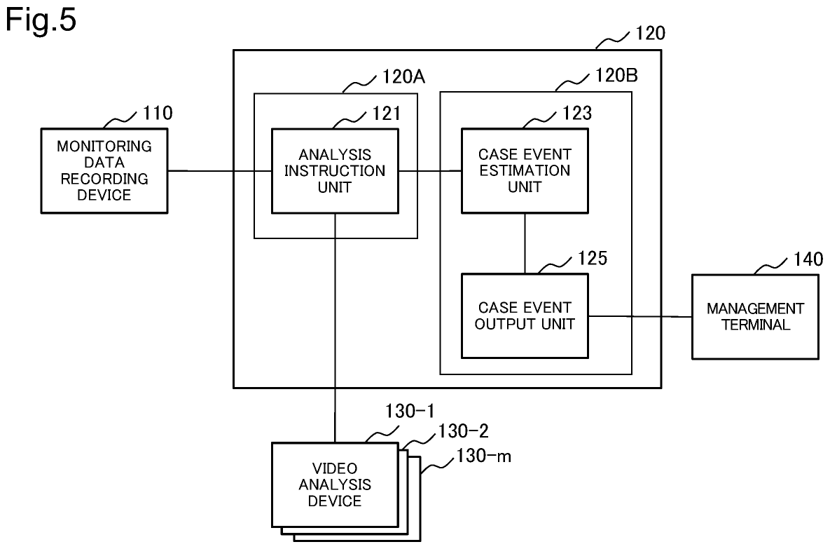

The estimation unit 120B acquires an analysis result by the video analysis device 130 according to the analysis instruction. The estimation unit 120B acquires an analysis result by the video analysis device 130 regardless of the presence or absence of an analysis instruction. The estimation unit 120B estimates a case event that has occurred in the area to be monitored based on the event detected by the monitoring terminal 100 and the event analyzed by the video analysis device 130. The estimation unit 120B outputs the estimated case event to the management terminal 140. An example of the configuration of the management device 120 will be described in more detail later with reference to FIG. 5.

The video analysis device 130 acquires the video data included in the monitoring data from the monitoring data recording device 110 at a preset timing. The video analysis device 130 acquires video data from the monitoring data recording device 110 in response to an analysis instruction from the management device 120. The video analysis device 130 analyzes the acquired video data and detects an event from the video data. When an event is detected in the area to be monitored, the video analysis device 130 generates an analysis result regarding the event detected from the video data. The video analysis device 130 outputs the generated analysis result to the management device 120.

The detection item by the monitoring terminal 100 and the detection item of the video analysis device 130 may be the same or different. When the detection item by the monitoring terminal 100 is different from the detection item by the video analysis device 130, the event detected by the monitoring terminal 100 and the event detected by the video analysis device 130 are combined, whereby the case event that has occurred in the area to be monitored can be estimated.

The management terminal 140 acquires the case event estimated by the management device 120. The management terminal 140 displays the information about the acquired case event on the screen. The management terminal 140 may be configured by a device different from the management device 120 or may be configured as part of the management device 120. For example, the management terminal 140 displays a field including the case event estimated by the management device 120 on the screen. For example, the management terminal 140 displays display information in which fields including the case event estimated by the management device 120 are disposed in time series on a screen. For example, the management terminal 140 collectively displays or switches the plurality of pieces of video data imaged by the plurality of monitoring terminals 100-1 to n on the screen. For example, management terminal 140 displays a user interface for switching the video in a window different from the window in which the video is displayed.

The management terminal 140 receives an operation by the user via an input device such as a keyboard or a mouse and changes the display information displayed on the screen. For example, the management terminal 140 changes the status related to handling of each case event to the field according to the operation by the user. For example, the management terminal 140 changes the status to “unread” before the field is selected, “read” after the field is selected, and “handled” after the action for the event of the field is taken according to the operation by the user.

Next, details of each component included in the monitoring system 1 of the present example embodiment will be described with reference to the drawings. The following components are merely an example, and the components included in the monitoring system 1 of the present example embodiment are not limited to the forms as they are.

[Monitoring Terminal]

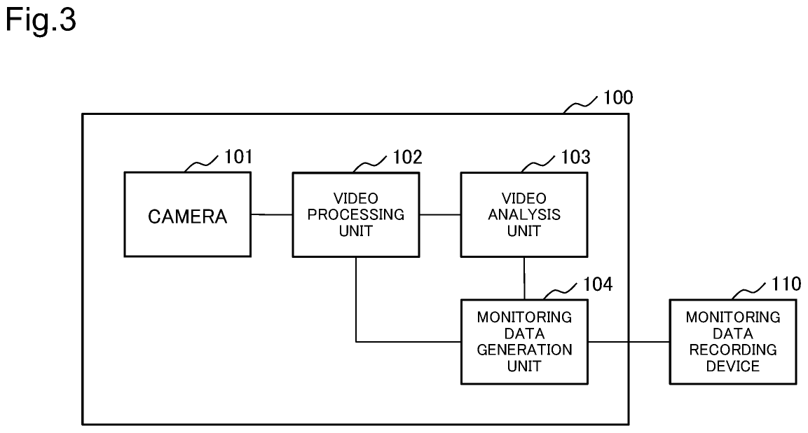

FIG. 3 is a block diagram illustrating an example of a configuration of the monitoring terminal 100. The monitoring terminal 100 includes a camera 101, a video processing unit 102, a video analysis unit 103, and a monitoring data generation unit 104. FIG. 3 also illustrates the monitoring data recording device 110 in addition to the monitoring terminal 100.

The camera 101 is disposed at a position where an image of the area to be monitored can be imaged. The camera 101 captures an image of the area to be monitored at a preset imaging interval and generates video data. The camera 101 outputs the imaged video data to the video processing unit 102. The camera 101 may be a normal monitoring camera sensitive to a visible region or an infrared camera sensitive to an infrared region. For example, the area within the range of the angle of view of the camera 101 is set to the area to be monitored. For example, the imaging direction of the camera 101 is switched according to an operation from the management terminal 140 or control from an external host system. For example, the imaging direction of the camera 101 is changed at a predetermined timing.

The video processing unit 102 acquires video data from the camera 101. The video processing unit 102 processes the video data in such a way as to have a data format that can be analyzed by the video analysis unit 103. The video processing unit 102 outputs the processed video data to the video analysis unit 103 and the monitoring data generation unit 104. For example, the video processing unit 102 performs at least any of processes such as a dark current correction, an interpolation operation, a color space conversion, a gamma correction, an aberration correction, a noise reduction, and an image compression on the frame image constituting the video data. The process on the video data by the video processing unit 102 is not limited to that described herein. When there is no need to process the video data, the video processing unit 102 may be omitted.

The video analysis unit 103 acquires the processed video data from the video processing unit 102. The video analysis unit 103 detects an event from the acquired video data. For example, the video analysis unit 103 analyzes a plurality of consecutive frame images included in the video data, and detects an event occurring in the area to be monitored. When detecting an event from the video data, the video analysis unit 103 outputs a type of the event detected from the video data to the monitoring data generation unit 104.

For example, the video analysis unit 103 includes a video analysis engine capable of detecting a preset event. For example, the analysis engine included in the video analysis unit 103 has a function of performing a video analysis by AI. For example, the video analysis unit 103 detects an event such as a person-in-nap, carrying away something, leaving something, a crowd, tumbling, a speed change, a posture change, wandering, or a vehicle. For example, the video analysis unit 103 may compare video data of at least two time zones having different imaging time zones and detect an event based on a difference between the video data.

For example, the video analysis unit 103 detects a person-in-nap state based on a detection condition under which a state in which a person sits on the ground and a state in which the person lies down can be detected. For example, the video analysis unit 103 detects carrying away a baggage based on a detection condition under which carrying away a baggage such as a bag or a wallet placed around the person-in-nap can be detected. For example, the video analysis unit 103 detects leaving something based on a detection condition under which that an object left behind/discarded is a designated object can be detected. For example, the designated object is a bag or the like.

For example, the video analysis unit 103 detects a crowd based on a detection condition under which that a crowd is generated in a specific area can be detected. It is preferable to designate ON/OFF of crowd detection and a time during which a crowd is gathering in order to avoid erroneous detection in an area where a crowd may constantly occur, such as near an intersection. For example, the video analysis unit 103 detects tumbling based on a detection condition under which a state in which a person has tumbled on the ground can be detected. For example, the video analysis unit 103 detects tumbling based on a detection condition under which a state in which a person riding on the two-wheeled vehicle has tumbled onto the ground can be detected.

For example, the video analysis unit 103 detects wandering based on a detection condition under which that an object continuously appears within a preset angle of view and has stayed in the specific area for a certain period of time can be detected. For example, when an object that continuously appears within the same angle of view can be detected by tracking the object even during the pan/tilt/zoom operation, the video analysis unit 103 can detect wandering based on a detection condition under which that the object has stayed within the specific area for a certain period of time can be detected. The object to be subjected to detection of wandering includes a vehicle such as an automobile or a two-wheeled vehicle, and a person.

For example, the video analysis unit 103 detects a vehicle based on a detection condition under which that the object is a vehicle such as a two-wheeled vehicle or an automobile based on the size and shape of the object can be detected. For example, the video analysis unit 103 may detect a vehicle based on a detection condition under which a moving object having a constant speed or higher can be detected as an automobile. For example, the video analysis unit 103 may detect an event such as a vehicle or a case event such as a traffic accident based on a combination of speed changes of a plurality of objects. For example, the video analysis unit 103 may detect a speed change based on a detection condition under which an object having a sudden speed change can be detected. For example, the video analysis unit 103 detects a speed change from a low speed state of about 3 to 5 km/h to a high speed state of 10 km/h or more.

Monitoring data generation unit 104 acquires the video data from video processing unit 102. Monitoring data generation unit 104 generates monitoring data in which the acquired video data is associated with metadata of the video data. For example, the metadata of the video data includes a place where the monitoring terminal 100 is disposed, an identification number of the monitoring terminal 100, an imaging time of the video data, and the like. Monitoring data generation unit 104 outputs the generated monitoring data to the monitoring data recording device 110.

When an event is detected from video data, the monitoring data generation unit 104 acquires a type of the event detected from the video data from the video analysis unit 103. The monitoring data generation unit 104 adds the type of the event detected from the video data to the metadata. The monitoring data generation unit 104 outputs the monitoring data in which the type of the event detected from the video data is added to the metadata to the monitoring data recording device 110.

[Monitoring Data Recording Device]

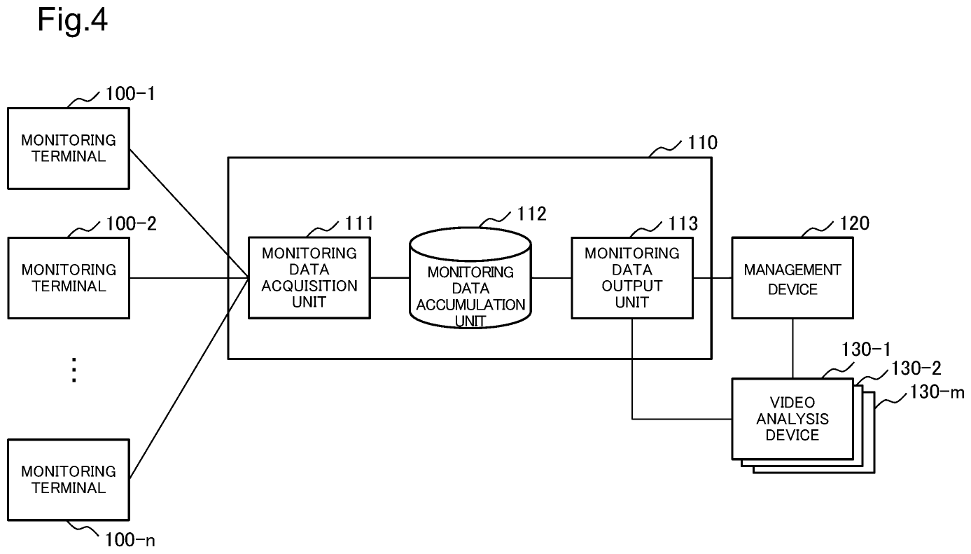

FIG. 4 is a block diagram illustrating an example of a configuration of the monitoring data recording device 110. The monitoring data recording device 110 includes a monitoring data acquisition unit 111, a monitoring data accumulation unit 112, and a monitoring data output unit 113. FIG. 4 illustrates the monitoring terminals 100-1 to n, the management device 120, and the video analysis device 130 in addition to the monitoring data recording device 110.

The monitoring data acquisition unit 111 acquires the monitoring data generated by each of the plurality of monitoring terminals 100-1 to n (hereinafter, referred to as a monitoring terminal 100.) from each of the plurality of monitoring terminals 100. The monitoring data acquisition unit 111 records the acquired monitoring data in the monitoring data accumulation unit 112 for each monitoring terminal 100 that is a generation source of the monitoring data.

The monitoring data accumulation unit 112 accumulates monitoring data generated by each of the plurality of monitoring terminals 100 in association with the monitoring terminal 100 from which the monitoring data is generated.

Monitoring data output unit 113 outputs the metadata included in the monitoring data to the management device 120 at a preset timing. For example, when acquiring the monitoring data from the monitoring terminal 100, the monitoring data output unit 113 immediately outputs the metadata included in the monitoring data to the management device 120. For example, the monitoring data output unit 113 may be configured to output metadata to be output included in the monitoring data accumulated in the monitoring data accumulation unit 112 to the management device 120. The monitoring data output unit 113 outputs the video data to be output included in the monitoring data accumulated in the monitoring data accumulation unit 112 to the video analysis device 130 at a preset timing. In response to an instruction from the management device 120 or the video analysis device 130, the monitoring data output unit 113 outputs the designated video data among the video data accumulated in the monitoring data accumulation unit 112 to the video analysis device 130 as a designation source.

[Management Device]

FIG. 5 is a block diagram illustrating an example of a configuration of the management device 120. The management device 120 includes the instruction unit 120A and the estimation unit 120B. The instruction unit 120A includes an analysis instruction unit 121. The estimation unit 120B includes a case event estimation unit 123 and a case event output unit 125. FIG. 5 illustrates the monitoring data recording device 110, the video analysis devices 130-1 to m, and the management terminal 140 in addition to the management device 120.

The analysis instruction unit 121 acquires the metadata generated by any of the monitoring terminals 100 from the monitoring data recording device 110. The analysis instruction unit 121 determines whether the type of the event is included in the acquired metadata. When the metadata includes the type of the event, the analysis instruction unit 121 outputs the type of the event included in the metadata to the case event estimation unit 123, and outputs an analysis instruction for the video data to any of the video analysis devices 130-1 to m. For example, when the type of the event is included in the metadata, the analysis instruction unit 121 outputs, to any of the video analysis devices 130-1 to m, an analysis instruction for video data in a time zone (also referred to as a designated time zone) including a time of detection of the event among the video data generated by the monitoring terminal 100 that has detected the event.

For example, when the metadata includes the type of the event, the analysis instruction unit 121 sorts an analysis instruction for the video data in the designated time zone into any of the plurality of video analysis devices 130-1 to m to output it. In this case, the analysis instruction unit 121 determines the output destination of the analysis instruction according to the operating status of the video analysis device 130. For example, the analysis instruction unit 121 issues an analysis instruction to any of the video analysis devices 130 having a load lower than the reference value. For example, the management device 120 issues an analysis instruction to the video analysis device 130 with the lowest load. By distributing the output destinations of the analysis instructions according to the operating status of the video analysis device 130, it is possible to reduce a delay in processing depending on the operating status of the video analysis device 130.

The analysis instruction unit 121 acquires an analysis result by the video analysis device 130 according to the analysis instruction. The analysis instruction unit 121 acquires the analysis result by the video analysis device 130 regardless of the presence or absence of the analysis instruction. The analysis instruction unit 121 outputs the acquired analysis result to the case event estimation unit 123.

The case event estimation unit 123 acquires the type of the event included in the metadata and the analysis result by the video analysis device 130 from the analysis instruction unit 121. The case event estimation unit 123 estimates a case event that has occurred in the area to be monitored based on the event detected by the monitoring terminal 100 and the event analyzed by the video analysis device 130. The case event estimation unit 123 outputs information about the estimated case event to the case event output unit 125.

In a case where the analysis result cannot be acquired from the video analysis device 130 within the predetermined time limit, the case event estimation unit 123 estimates the case event that has occurred in the area to be monitored based on the event detected by the monitoring terminal 100. For example, the delay of the analysis process by the video analysis device 130 can also be determined by a response, a delay, a length of a queue, or the like. In such a case, the case event estimation unit 123 estimates a plurality of case events estimated based on the event detected by the monitoring terminal 100.

Even when the analysis instruction unit 121 does not issue an analysis instruction, an analysis result may be transmitted from the video analysis device 130. In this case, the case event estimation unit 123 estimates the case event that has occurred in the area to be monitored based on the analysis result sent from the video analysis device 130.

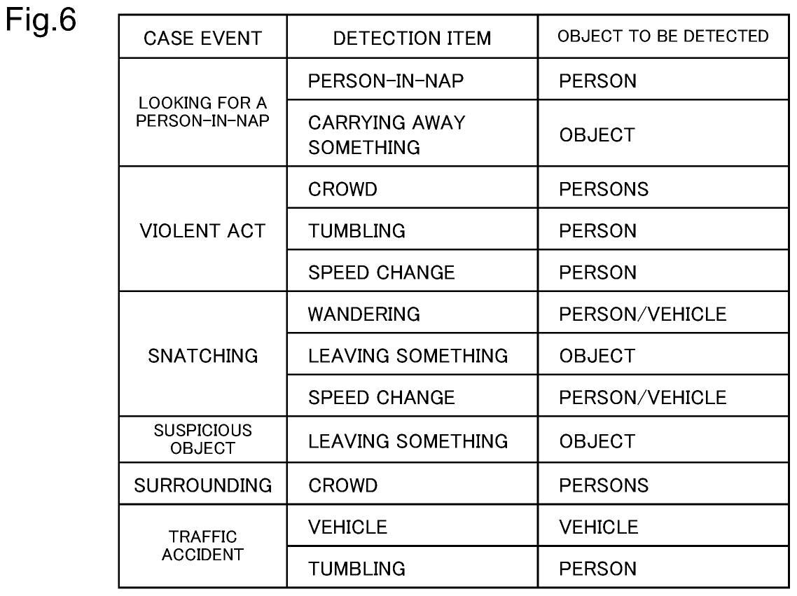

FIG. 6 is a table summarizing an example of the case event to be estimated. FIG. 6 illustrates, as case events, looking for a person-in-nap, a violent act, snatching, a suspicious object, surrounding, and a traffic accident. Hereinafter, an example in which the case event is estimated based on video data of a certain area to be monitored imaged in the same time zone will be listed.

Looking for a person-in-nap is a case event of stealing an article carried by a person who falls asleep. For example, when it is detected that a person-in-nap and carrying away something in video data imaged in the same time zone with respect to a certain area to be monitored, the case event estimation unit 123 estimates looking for a person-in-nap as a case event. The object to be detected in terms of the person-in-nap is a person, and the object to be detected in terms of carrying away something is a bag, a wallet, or the like.

A violent act is a case event including an overall act in which an act of someone harms another person. For example, when a crowd, tumbling, and a speed change are detected in video data imaged in the same time zone for a certain area to be monitored, the case event estimation unit 123 estimates that a violent act has occurred as a case event. The objects to be detected in terms of crowd are persons, and the object to be detected in terms of tumbling and a speed change is a person.

Snatching is a case event in which a person forcibly takes away an object carried by another person. For example, when wandering, leaving something, and a speed change are detected in the video data imaged in the same time zone with respect to a certain area to be monitored, the case event estimation unit 123 estimates that snatching has occurred as a case event. The object to be detected in terms of wandering is a person/vehicle, the object to be detected in terms of leaving something is an object, and the object to be detected in terms of a speed change is a person/vehicle.

The suspicious object is a case event in which an object such as a bag is left. For example, when leaving something is detected in video data imaged in the same time zone with respect to a certain area to be monitored, the case event estimation unit 123 estimates a suspicious object as a case event. The object to be detected in terms of leaving something is an object such as a bag.

Surrounding is a case event in which a plurality of people gather at one place. Surrounding is a case event in which a person is surrounded by a plurality of other persons. For example, when a crowd is detected in video data imaged in the same time zone for a certain area to be monitored, the case event estimation unit 123 estimates surrounding as a case event. The object to be detected in terms of surrounding is a person/crowd.

A traffic accident is a case event including an overall act that harm a human body by a vehicle. For example, when a vehicle and tumbling are detected in video data imaged in the same time zone for a certain area to be monitored, the case event estimation unit 123 estimates a traffic accident as a case event. The object to be detected in terms of vehicle is a two-wheeled vehicle/automobile, and the object to be detected in terms of tumbling is a person.

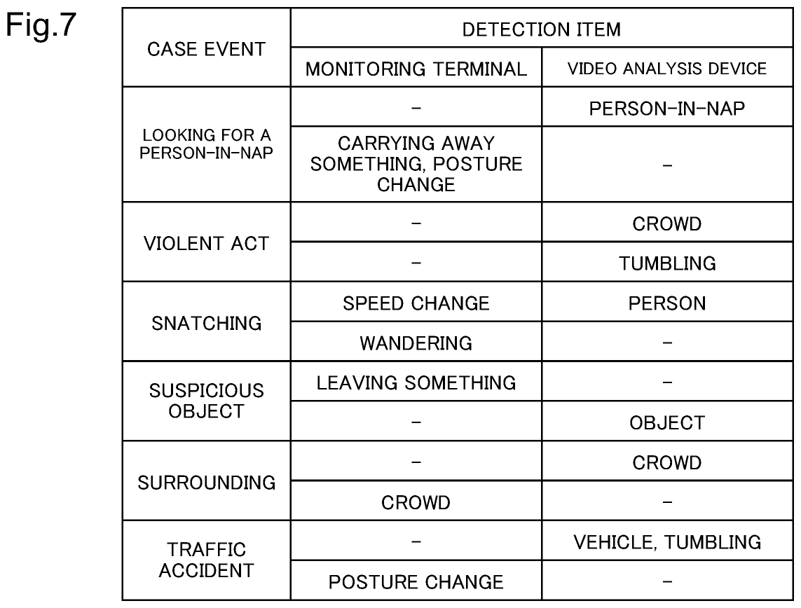

FIG. 7 is a table summarizing exemplary case events estimated by combining a detection item by the monitoring terminal 100 and a detection item by the video analysis device 130. As in FIG. 6, FIG. 7 illustrates, as case events, looking for a person-in-nap, a violent act, snatching, a suspicious object, surrounding, and a traffic accident. The detection items that are the basis of the estimation of the case event summarized in the table of FIG. 7 are examples, and there are cases different from those summarized in the table of FIG. 6.

Hereinafter, an example in which the case event is estimated based on video data of a certain area to be monitored imaged in the same time zone will be listed. For example, when carrying away something or a posture change is detected by the monitoring terminal 100 and a person-in-nap is detected by the video analysis device 130, the case event estimation unit 123 estimates that looking for a person-in-nap has occurred as a case event. For example, when a crowd and tumbling are detected by the video analysis device 130, the case event estimation unit 123 estimates that a violent act has occurred as a case event. For example, when a speed change and wandering is detected by the monitoring terminal 100 and a person is detected by the video analysis device 130, the case event estimation unit 123 estimates that snatching has occurred as a case event. For example, when a crowd is detected by the monitoring terminal 100 and when a crowd is detected by the video analysis device 130, the case event estimation unit 123 estimates that surrounding has occurred as a case event. For example, when a posture change is detected by the monitoring terminal 100 and a vehicle or tumbling is detected by the video analysis device 130, the case event estimation unit 123 estimates that a traffic accident has occurred as a case event.

The case event output unit 125 acquires information about the case event from the case event estimation unit 123. The case event output unit 125 outputs the acquired information about the case event to the management terminal 140. For example, the case event output unit 125 displays information about the case event on the screen of the management terminal 140. For example, the case event output unit 125 displays display information including a case event in which the area to be monitored in which the case event has occurred, the time of detection of the case event, and the type of the case event are associated with each other on the screen of the management terminal 140.

[Video Analysis Device]

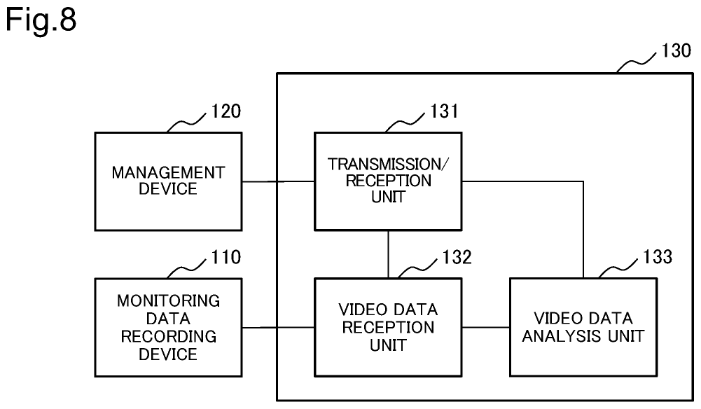

FIG. 8 is a block diagram illustrating an example of a configuration of the video analysis device 130. The video analysis device 130 includes a transmission/reception unit 131, a video data reception unit 132, and a video data analysis unit 133. FIG. 8 illustrates the monitoring data recording device 110 and the management device 120 in addition to the video analysis device 130.

The transmission/reception unit 131 receives the analysis instruction from the management device 120. The transmission/reception unit 131 outputs the received analysis instruction to the video data reception unit 132 and the video data analysis unit 133. The transmission/reception unit 131 acquires an analysis result from the video data analysis unit 133. The transmission/reception unit 131 transmits the analysis result to the management device 120.

Video data reception unit 132 receives video data from the monitoring data recording device 110. The video data reception unit 132 outputs the received video data to the video data analysis unit 133. For example, in response to an analysis instruction from the management device 120, the video data reception unit 132 makes a request of the monitoring data recording device 110 for the video data generated by the monitoring terminal 100 designated in the designated time zone. The video data reception unit 132 outputs the video data transmitted in response to the request to the video data analysis unit 133. The video data reception unit 132 outputs the video data transmitted from the monitoring data recording device 110 at a predetermined timing to the video data analysis unit 133.

The video data analysis unit 133 acquires the video data from the video data reception unit 132. The video data analysis unit 133 analyzes the acquired video data and detects an event from the video data. For example, the video data analysis unit 133 analyzes each frame image constituting the video data, and detects an event occurring in the area to be monitored. The video data analysis unit 133 generates an analysis result including the type of the event detected from the video data. The video data analysis unit 133 outputs the generated analysis result to the transmission/reception unit 131.

For example, the video data analysis unit 133 includes a video analysis engine capable of detecting a preset event. For example, the analysis engine included in the video data analysis unit 133 has a function of performing a video analysis by AI. For example, the video data analysis unit 133 detects a person-in-nap, carrying away something, leaving something, a crowd, tumbling, a speed change, a posture change, wandering, a vehicle, and the like from the video data. The detection item by the video data analysis unit 133 and the detection item by the monitoring terminal 100 may be the same or different.

[Management Terminal]

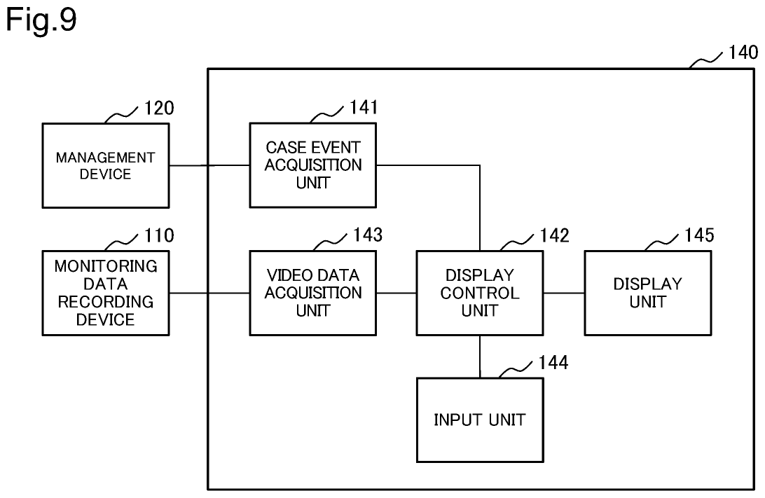

FIG. 9 is a block diagram illustrating an example of a configuration of the management terminal 140. The management terminal 140 includes a case event acquisition unit 141, a display control unit 142, a video data acquisition unit 143, an input unit 144, and a display unit 145. FIG. 9 illustrates the monitoring data recording device 110 and the management device 120 in addition to the management terminal 140.

The case event acquisition unit 141 acquires information about the case event from the management device 120. The case event acquisition unit 141 outputs the acquired information about the case event to the display control unit 142.

The display control unit 142 acquires information about the case event from the case event acquisition unit 141. The display control unit 142 causes the display unit 145 to display the acquired information about the case event. For example, the display control unit 142 causes the display unit 145 to display display information in which fields including information about the case events are stacked in time series. For example, the display control unit 142 displays the status indicating the response status to the case event in each field in response to the operation by the user as “unread”, “read”, “handled”, or the like in response to the selection of the field.

For example, the display control unit 142 causes the display unit 145 to display the video data transmitted from the monitoring data recording device 110 at a predetermined timing. For example, the display control unit 142 causes the display unit 145 to display collectively or display side by side the video data generated by the plurality of monitoring terminals 100. For example, the display control unit 142 may cause the display unit 145 to display collectively or side by side the user interface of the video monitoring function installed in the management device 140 and the video data. The display control unit 142 may output an instruction to acquire the designated video data to the video data acquisition unit 143 according to the designation from the user via the input unit 144. For example, the display control unit 142 acquires the video data transmitted in response to the acquisition instruction from the video data acquisition unit 143 and causes the display unit 145 to display the acquired video data.

The video data acquisition unit 143 acquires video data from the monitoring data recording device 110. For example, the video data acquisition unit 143 receives the designated video data from the monitoring data recording device 110 according to the designation of the display control unit 142. The video data acquisition unit 143 outputs the received video data to the display control unit 142.

The input unit 144 is an input device such as a keyboard or a mouse that receives an operation by a user. The input unit 144 receives an operation by the user via the input device to output the received operation content to the display control unit 142.

The display unit 145 includes a screen on which display information including information about the case event generated by the management device 120 is displayed. The display unit 145 displays display information including information about the case event generated by the management device 120. For example, the display unit 145 displays display information in which information about the case event generated by the management device 120 is disposed in time series. For example, the display unit 145 displays collectively, displays side by side or displays switchably frame images of a plurality of pieces of video data imaged by a plurality of monitoring terminals 100-1 to n on a screen. For example, the display unit 145 may display collectively or side by side the user interface of the video monitoring function installed in the management device 140 and the video data.

(Operation)

Next, an operation of the monitoring system 1 of the present example embodiment will be described with reference to the drawings. Hereinafter, the operation of each component included in the monitoring system 1 will be individually described.

[Monitoring Terminal]

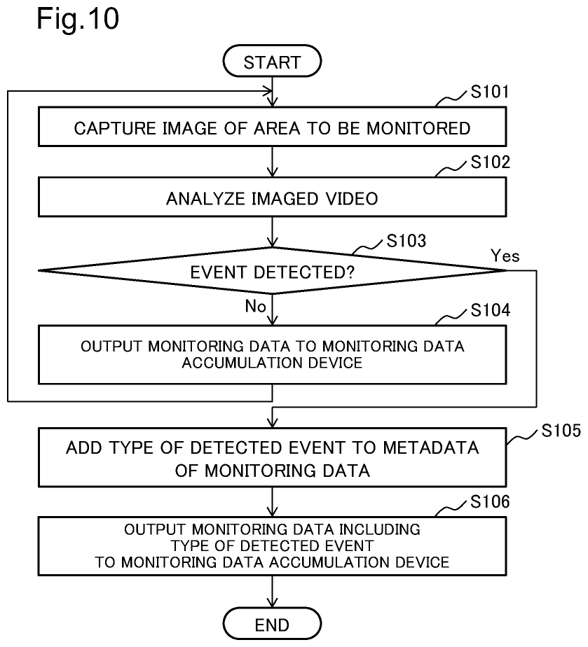

FIG. 10 is a flowchart for explaining an example of the operation of the monitoring terminal 100. In the description along the flowchart of FIG. 10, the monitoring terminal 100 will be described as a main operation.

In FIG. 10, first, monitoring terminal 100 captures an image of an area to be monitored (step S101).

Next, the monitoring terminal 100 analyzes the imaged video data (step S102).

Here, when an event is detected from the video data (Yes in step S103), the monitoring terminal 100 adds the type of the detected event to the metadata of the monitoring data (step S105).

Next, the monitoring terminal 100 outputs monitoring data including the type of the detected event to the monitoring data accumulation device (step S106). After step S106, the process according to the flowchart of FIG. 10 may be ended, or the process may be continued by returning to step S101.

On the other hand, when no event is detected from the video data in step S103 (No in step S103), the monitoring terminal 100 generates monitoring data in which metadata is added to the video data, and then output the generated monitoring data to the monitoring data accumulation device (step S104). After step S104, the process may return to step S101 to continue the process, or the process according to the flowchart of FIG. 10 may be ended.

[Monitoring Data Recording Device]

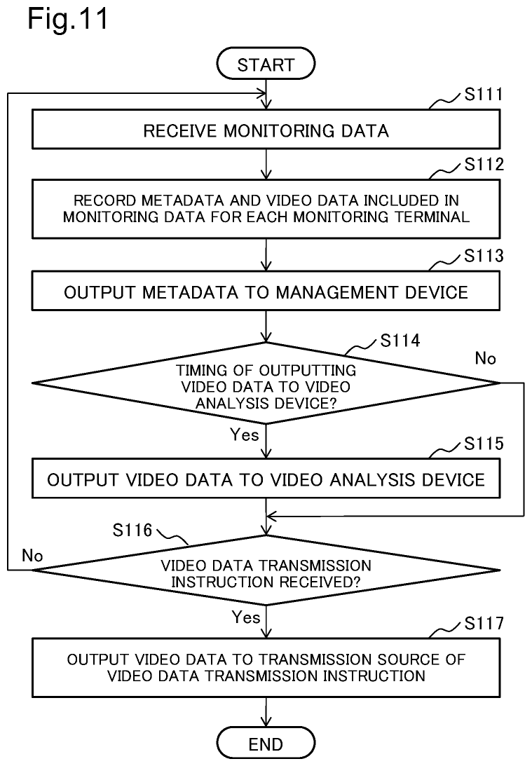

FIG. 11 is a flowchart for explaining an example of the operation of the monitoring data recording device 110. In the description along the flowchart of FIG. 11, the monitoring data recording device 110 will be described as an operation subject.

In FIG. 11, first, the monitoring data recording device 110 receives the monitoring data from the monitoring terminal 100 (step S111).

Next, the monitoring data recording device 110 records the metadata and the video data included in the monitoring data for each monitoring terminal (step S112).

Next, the monitoring data recording device 110 outputs the metadata to the management device 120 (step S113).

Here, in the case of the timing of outputting the video data to the video analysis device 130 (Yes in step S114), the monitoring data recording device 110 outputs the video data to the video analysis device 130 (step S115). After step S115, the process proceeds to step S116. On the other hand, when it is not the timing to output the video data to the video analysis device 130 in step S114 (No in step S114), the process also proceeds to step S116.

Here, when receiving the instruction to transmit video data (Yes in step S116), the monitoring data recording device 110 outputs the video data to the transmission source of the video data transmission instruction (step S117). After step S117, the process according to the flowchart of FIG. 11 may be ended, or the process may be continued by returning to step S111.

On the other hand, when the instruction to transmit the video data is not received in step S116 (No in step S116), the process may return to step S111 to continue the process, or the process according to the flowchart in FIG. 11 may be ended.

[Management Device]

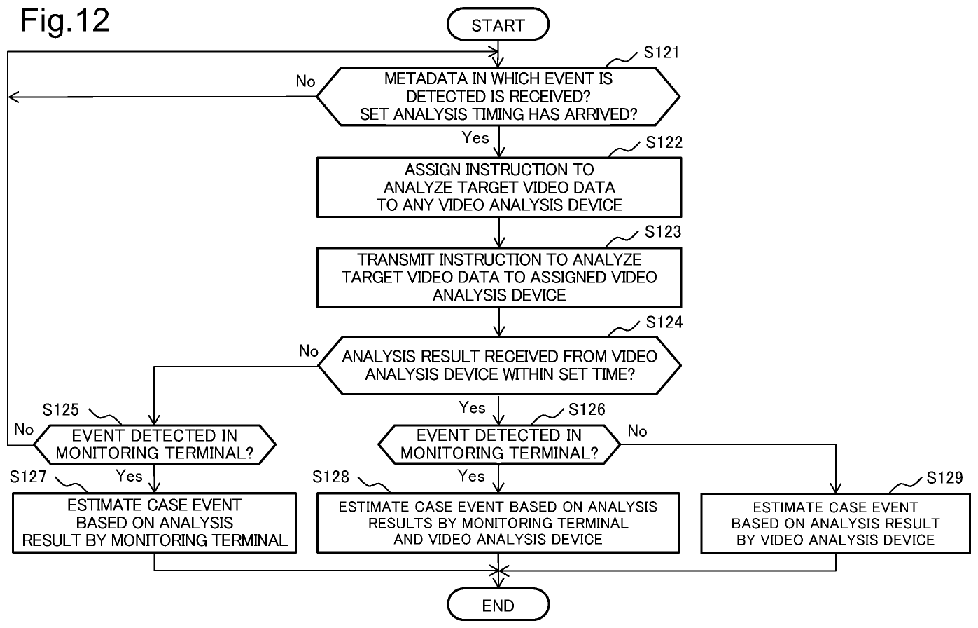

FIG. 12 is a flowchart for explaining the operation of the management device 120. In the description along the flowchart of FIG. 12, the management device 120 will be described as an operation subject.

In FIG. 12, first, when metadata in which an event is detected is received or a set analysis timing arrives (Yes in step S121), the management device 120 assigns an analysis instruction for target video data to any of the video analysis devices 130 (step S122). On the other hand, in a case where the set analysis timing has not arrived (No in step S121), the process waits until the metadata is received or the set analysis timing arrives.

After step S122, the management device 120 transmits the analysis instruction for the target video data to the video analysis device 130 to which the analysis instruction is assigned (step S123).

Here, when the analysis result has not been received from the video analysis device 130 within the set period (No in step S124), the process proceeds to step S125. On the other hand, when the analysis result is received from the video analysis device 130 within the set period (Yes in step S124), the process proceeds to step S126.

In step S125, when the event is detected by the monitoring terminal 100 (Yes in step S125), the management device 120 estimates the case event based on the event detected by the monitoring terminal 100 (step S127). After step S127, the process according to the flowchart of FIG. 12 may be ended, or the process may be continued by returning to step S121. On the other hand, when no event is detected by the monitoring terminal 100 (No in step S125), the process returns to step S121.

In step S126, when the event is detected by the monitoring terminal 100 (Yes in step S126), the management device 120 estimates the case event based on the events detected by the monitoring terminal 100 and the video monitoring device 130 (step S128). On the other hand, when no event is detected by the monitoring terminal 100 (No in step S126), the management device 120 estimates the case event based on the event of the analysis result by the video analysis device 130 (step S129). After steps S128 and S129, the process according to the flowchart of FIG. 12 may be ended, or the process may be continued by returning to step S121.

[Video Analysis Device]

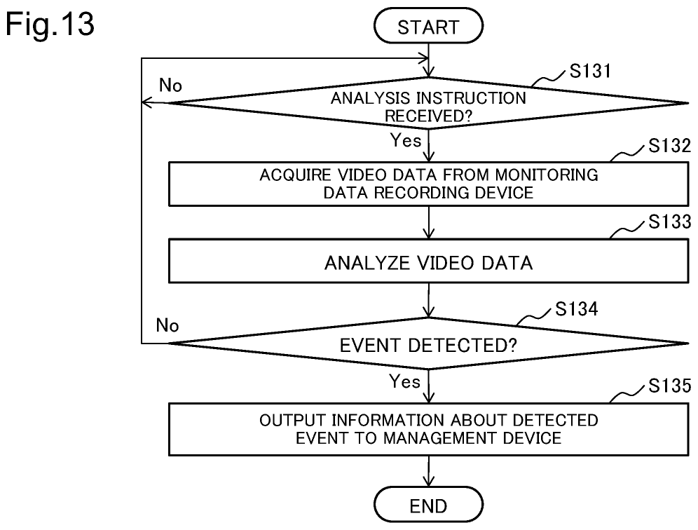

FIG. 13 is a flowchart for explaining the operation of the video analysis device 130. In the description along the flowchart of FIG. 13, the video analysis device 130 will be described as a main operation.

In FIG. 13, first, when an analysis instruction is received (Yes in step S131), the video analysis device 130 acquires video data to be analyzed from the monitoring data recording device 110 (step S132). In a case where the analysis instruction has not been received (No in step S131), the process waits.

After step S132, the video analysis device 130 analyzes the video data to be analyzed according to the analysis instruction (step S133).

When an event is detected from the video data (Yes in step S134), the video analysis device 130 outputs information about the detected event to the management device 120 (step S135). After step S135, the process according to the flowchart of FIG. 13 may be ended, or the process may be continued by returning to step S131.

On the other hand, when no event is detected from the video data in step S134 (No in step S134), the process may return to step S131 to continue the process, or the process according to the flowchart in FIG. 13 may be ended.

[Management Terminal]

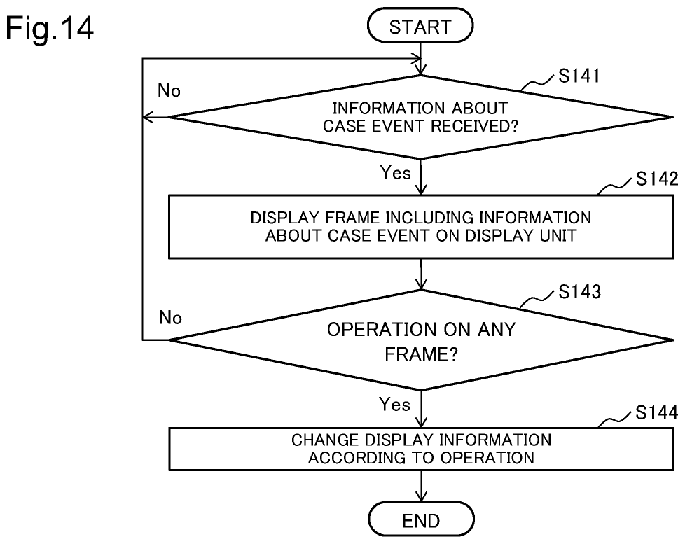

FIG. 14 is a flowchart for explaining an example of the operation of the management terminal 140. In the description along the flowchart of FIG. 14, the management terminal 140 will be described as an operation subject.

In FIG. 14, first, in a case where the information about the case event is received (Yes in step S141), the management terminal 140 displays a frame including the information about the case event on the screen (step S142). On the other hand, in a case where the information about the case event has not been received (No in step S141), reception of the information about the case event is waited.

After step S142, when there is an operation on any frame (Yes in step S143), the management terminal 140 changes the screen display according to the operation (step S144). After step S144, the process according to the flowchart of FIG. 14 may be ended, or the process may be continued by returning to step S141.

On the other hand, in a case where there is no operation on the frame in step S143 (No in step S143), the process may return to step S141 to continue the process, or the process along the flowchart of FIG. 14 may be ended.

As described above, the monitoring system of the present example embodiment includes at least one monitoring terminal, a monitoring data recording device, a management device, at least one video analysis device, and a management terminal. The monitoring terminal captures an image of an area to be monitored to generate video data, and detects an event from the video data. The monitoring data recording device records monitoring data in which video data generated by the monitoring terminal and metadata of the video data are associated with each other.

In an aspect of the present example embodiment, the management device includes an instruction unit and an estimation unit. The instruction unit acquires the metadata of the video data generated by the monitoring terminal that detects the event from the video data of the area to be monitored. When the acquired metadata includes the information about the event, the instruction unit outputs an analysis instruction for the video data of the area to be monitored imaged in the time zone including a time of detection of the event to the video analysis device that detects the event from the video data. The instruction unit acquires an analysis result including information about an event detected from the video data by analysis by the video analysis device. The estimation unit estimates a case event that has occurred in the area to be monitored based on an event detected by the monitoring terminal and an event detected by the video analysis device.

In an aspect of the present example embodiment, the instruction unit determines a video analysis device to which an analysis instruction is to be transmitted according to operating statuses of a plurality of video analysis devices. According to the present aspect, since the video analysis server that analyzes the video data is assigned according to the operating statuses of the plurality of video analysis devices, it is possible to reduce a delay in processing due to a load factor of the video analysis server.

In an aspect of the present example embodiment, in a case where the analysis result is not acquired within a predetermined time from the video analysis device to which the analysis instruction is to be output, the estimation unit estimates the case event that has occurred in the area to be monitored based on the event detected by the monitoring terminal. In an aspect of the present example embodiment, in a case where the analysis result is acquired from the video analysis device to which the analysis instruction is not to be output, the estimation unit estimates the case event that has occurred in the area to be monitored based on the event detected by the video analysis device. According to the present aspect, even in a case where no event is detected in the video analysis device or no event is detected in the monitoring terminal, it is possible to estimate a candidate for a case event that has occurred in the area to be monitored.

In an aspect of the present example embodiment, the monitoring terminal and the video analysis device each include analysis engines in which different events are set as a detection item. The case event estimation unit estimates a case event based on a combination of events detected using at least two analysis engines different from each other. According to the present aspect, since the detection item can be shared by the monitoring terminal and the video analysis device, it is possible to reduce processing when events are detected from the video data.

In an aspect of the present example embodiment, the monitoring terminal and the video analysis device set, as a detection item, the event of at least any of a person-in-nap, carrying away something, a crowd, tumbling, a posture change, a speed change, wandering, leaving something, and a vehicle. The estimation unit estimates a case event of at least any of looking for a person-in-nap, a violent act, snatching, a suspicious object, surrounding, and a traffic accident based on a combination of the events included in the detection item. According to the present aspect, a desired case event can be estimated based on a combination of specific events.

In the present example embodiment, an example of estimating a case event based on an event detected in video data is described. However, the method of the present example embodiment can also be applied to estimating a case event based on an event detected in sensing data other than video data. For example, the method of the present example embodiment can also be applied to estimating a case event based on an event detected in voice data. For example, the method of the present example embodiment can also be applied to estimating a case event based on the event such as scream detected in the voice data.

For example, sensing data detected in remote sensing such as light detection and ranging (LIDAR) may be used in the method of the present example embodiment. For example, it can be determined that the detected object is not an object to be detected according to the distance to the object measured by LIDAR or the like. For example, when the distance to the object is known, the size of the object can be grasped, but when the size of the object to be detected is smaller than expected, there is a possibility of erroneous detection. In such a case, the detected event may be determined as false detection and removed from the estimation of the case event.

### Second Example Embodiment

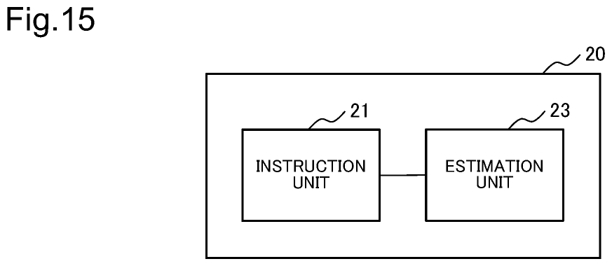

Next, a management device according to a second example embodiment will be described with reference to the drawings. FIG. 15 is a block diagram illustrating an example of a configuration of a management device 20 according to the present example embodiment. The management device 20 includes an instruction unit 21 and an estimation unit 23. The management device 20 has a configuration in which the management device 120 of the first example embodiment is simplified.

Instruction unit 21 acquires the metadata of the video data generated by the monitoring terminal (not illustrated) that detects the event from the video data of the area to be monitored. When the acquired metadata includes the information about the event, the instruction unit 21 outputs an analysis instruction for the video data of the area to be monitored imaged in the time zone including a time of detection of the event to the video analysis device (not illustrated) that detects the event from the video data. The instruction unit 21 acquires an analysis result including information about the event detected from the video data by an analysis by the video analysis device.

The estimation unit 23 estimates a case event that has occurred in the area to be monitored based on an event detected by the monitoring terminal and an event detected by the video analysis device.

As described above, the management device according to the present example embodiment includes the instruction unit and the estimation unit. The instruction unit acquires the metadata of the video data generated by the monitoring terminal that detects the event from the video data of the area to be monitored. When the acquired metadata includes the information about the event, the instruction unit outputs an analysis instruction for the video data of the area to be monitored imaged in the time zone including a time of detection of the event to the video analysis device that detects the event from the video data. The instruction unit acquires an analysis result including information about an event detected from the video data by analysis by the video analysis device. The estimation unit estimates a case event that has occurred in the area to be monitored based on an event detected by the monitoring terminal and an event detected by the video analysis device.

According to the present example embodiment, the event detected by the monitoring terminal and the event detected by the video analysis device are used for the video data obtained by captures an image of the area to be monitored, whereby the case event can be estimated based on the video data.

(Hardware)

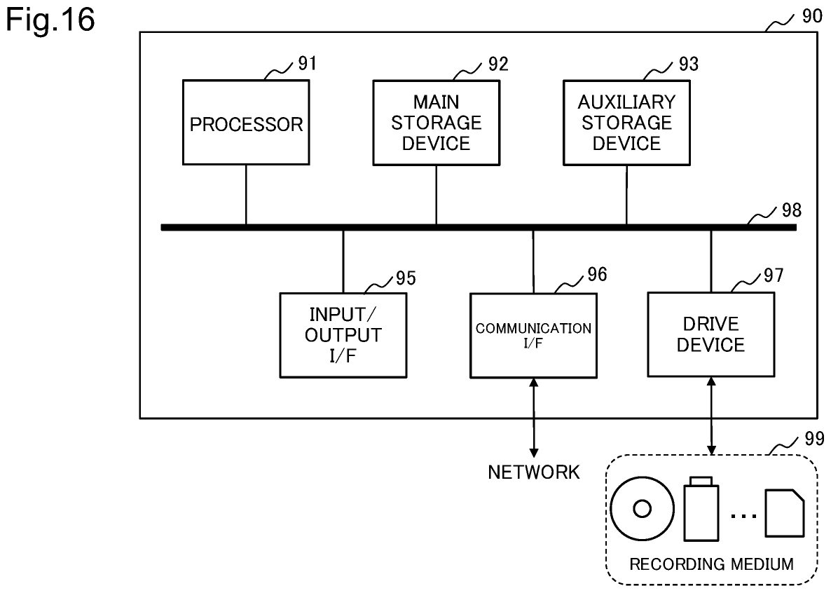

A hardware configuration for executing processing of the device and the terminal according to each example embodiment will be described using an information processing apparatus 90 of FIG. 16 as an example. The information processing apparatus 90 in FIG. 16 is a configuration example for executing processing of the device and the terminal of each example embodiment, and does not limit the scope of the present invention.

As illustrated in FIG. 16, the information processing apparatus 90 includes a processor 91, a main storage device 92, an auxiliary storage device 93, an input/output interface 95, a communication interface 96, and a drive device 97. In FIG. 16, the interface is abbreviated as an interface (I/F). The processor 91, the main storage device 92, the auxiliary storage device 93, the input/output interface 95, the communication interface 96, and the drive device 97 are data-communicably connected to each other via a bus 98. The processor 91, the main storage device 92, the auxiliary storage device 93, and the input/output interface 95 are connected to a network such as the Internet or an intranet via the communication interface 96. FIG. 16 illustrates a recording medium 99 capable of recording data.

The processor 91 develops the program stored in the auxiliary storage device 93 or the like in the main storage device 92 and executes the developed program. In the present example embodiment, a software program installed in the information processing apparatus 90 may be used. The processor 91 executes processing by the device or the terminal according to the present example embodiment.

The main storage device 92 has an area in which a program is developed. The main storage device 92 may be a volatile memory such as a dynamic random access memory (DRAM). A nonvolatile memory such as a magnetoresistive random access memory (MRAM) may be configured and added as the main storage device 92.

The auxiliary storage device 93 stores various pieces of data. The auxiliary storage device 93 includes a local disk such as a hard disk or a flash memory. Various pieces of data may be stored in the main storage device 92, and the auxiliary storage device 93 may be omitted.

The input/output interface 95 is an interface that connects the information processing apparatus 90 with a peripheral device. The communication interface 96 is an interface that connects to an external system or a device through a network such as the Internet or an intranet in accordance with a standard or a specification. The input/output interface 95 and the communication interface 96 may be shared as an interface connected to an external device.

An input device such as a keyboard, a mouse, or a touch panel may be connected to the information processing apparatus 90 as necessary. These input devices are used to input information and settings. When the touch panel is used as the input device, the display screen of the display device may also serve as the interface of the input device. Data communication between the processor 91 and the input device may be mediated by the input/output interface 95.

The information processing apparatus 90 may be provided with a display device that displays information. In a case where a display device is provided, the information processing apparatus 90 preferably includes a display control device (not illustrated) that controls display of the display device. The display device may be connected to the information processing apparatus 90 via the input/output interface 95.

The drive device 97 is connected to the bus 98. The drive device 97 mediates reading of data and a program from the recording medium 99, writing of a processing result of the information processing apparatus 90 to the recording medium 99, and the like between the processor 91 and the recording medium 99 (program recording medium). When the recording medium 99 is not used, the drive device 97 may be omitted.

The recording medium 99 can be achieved by, for example, an optical recording medium such as a compact disc (CD) or a digital versatile disc (DVD). The recording medium 99 may be achieved by a semiconductor recording medium such as a Universal Serial Bus (USB) memory or a secure digital (SD) card, a magnetic recording medium such as a flexible disk, or another recording medium. In a case where the program executed by the processor is recorded in the recording medium 99, the recording medium 99 corresponds to a program recording medium.

The above is an example of a hardware configuration for enabling the device and the terminal according to each example embodiment. The hardware configuration of FIG. 16 is an example of a hardware configuration for executing processing of the device or the terminal according to each example embodiment, and does not limit the scope of the present invention. A program for causing a computer to execute processing related to the device and the terminal according to each example embodiment is also included in the scope of the present invention. A program recording medium in which the program according to each example embodiment is recorded is also included in the scope of the present invention.

Components of the device and the terminal in each example embodiment can be arbitrarily combined. The components of the device and the terminal of each example embodiment may be implemented by software or may be implemented by a circuit.

While the present invention is described with reference to example embodiments thereof, the present invention is not limited to these example embodiments. Various modifications that can be understood by those skilled in the art can be made to the configuration and details of the present invention within the scope of the present invention.

### REFERENCE SIGNS LIST

1 monitoring system
10 management system
20 management device
21 instruction unit
23 estimation unit
100 monitoring terminal
101 camera
102 video processing unit
103 video analysis unit
104 monitoring data generation unit
110 monitoring data recording device
111 monitoring data acquisition unit
112 monitoring data accumulation unit
113 monitoring data output unit
120 management device
121 analysis instruction unit
123 case event estimation unit
125 case event output unit
130 video analysis device
131 transmission/reception unit
132 video data reception unit
133 video data analysis unit
140 management terminal
141 case event acquisition unit
142 display control unit
143 video data acquisition unit
144 input unit
145 display unit

What is claimed is:

1. A management device comprising:
at least one memory storing instructions; and
at least one processor connected to the at least one memory and configured to execute the instructions to:
acquire metadata of video data of an area to be monitored generated by a monitoring terminal that detects an event from the video data,
output, in response to an acquisition of metadata including information about the event, an analysis instruction for the video data of the area to be monitored imaged in a time zone including a time of detection of the event to a video analysis device that detects the event from the video data,
acquire an analysis result including information about the event detected from the video data by an analysis by the video analysis device; and
estimate a case event that has occurred in the area to be monitored based on the event detected by the monitoring terminal and the event detected by the video analysis device.

2. The management device according to claim 1, wherein
the at least one processor is configured to execute the instructions to
determine the video analysis device to which the analysis instruction is to be transmitted according to operating statuses of a plurality of the video analysis devices.

3. The management device according to claim 1, wherein
the at least one processor is configured to execute the instructions to
estimate the case event that has occurred in the area to be monitored based on the event detected by the monitoring terminal in a case where the analysis result is not acquired within a predetermined time from the video analysis device to which the analysis instruction is to be output.

4. The management device according to claim 1, wherein
the at least one processor is configured to execute the instructions to
estimate the case event that has occurred in the area to be monitored based on the event detected by the video analysis device in a case where the analysis result is acquired from the video analysis device to which the analysis instruction is not to be output.

5. The management device according to claim 1, wherein
the monitoring terminal and the video analysis device
include analysis engines in which the events different from each other are set as a detection item, and
the at least one processor is configured to execute the instructions to
estimate the case event based on a combination of the events detected using at least two of the analysis engines different from each other.

6. The management device according to claim 1, wherein
the monitoring terminal and the video analysis device is configured to
set, as a detection item, the event of at least any of a person-in-nap, carrying away something, a crowd, tumbling, a posture change, a speed change, wandering, leaving something, and a vehicle, and
the at least one processor is configured to execute the instructions to
estimate a case event of at least any of looking for a person-in-nap, a violent act, snatching, a suspicious object, surrounding, and a traffic accident based on a combination of the events included in the detection item.

7. A management system comprising:
the management device according to claim 1;
a monitoring data recording device that records monitoring data in which the video data generated by the monitoring terminal and the metadata of the video data are associated with each other; and
at least one of the video analysis devices that analyzes the video data included in the monitoring data recorded in the monitoring data recording device and detects the event from the video data.

8. A monitoring system comprising:
the management system according to claim 7; and
at least one monitoring terminal that generates the video data by capturing an image of the area to be monitored and detects the event from the video data.

9. An estimating method executed by a computer, the method comprising:
outputting, in a case where metadata of video data of an area to be monitored generated by a monitoring terminal that detects an event from the video data includes information about the event, an analysis instruction for the video data of the area to be monitored imaged in a time zone including the time of detection of the event to a video analysis device that detects the event from the video data;
acquiring an analysis result including information about the event detected from the video data by an analysis by the video analysis device; and
estimating a case event that has occurred in the area to be monitored based on the event detected by the monitoring terminal and the event detected by the video analysis device.

10. A non-transitory recording medium storing a program for causing a computer to execute processing of:
outputting, in a case where metadata of video data of an area to be monitored generated by a monitoring terminal that detects an event from the video data includes information about the event, an analysis instruction for the video data of the area to be monitored imaged in a time zone including a time of detection of the event to a video analysis device that detects the event from the video data;
acquiring an analysis result including information about the event detected from the video data by an analysis by the video analysis device; and
estimating a case event that has occurred in the area to be monitored based on the event detected by the monitoring terminal and the event detected by the video analysis device.
